(19) United States
(12) Patent Application Publication
(10) Pub. No.: US 2024/0400102 A1
(43) Pub. Date: Dec. 5, 2024

(54) SELF-PROPELLED CONVEYANCE SYSTEM

(71) Applicant: TOYOTA JIDOSHA KABUSHIKI KAISHA, Toyota-shi Aichi-ken (JP)

(72) Inventors: Hiroya CHIBA, Fuji-shi Shizuoka-ken (JP); Daisuke KAKUMA, Susono-shi Shizuoka-ken (JP); Kento IWAHORI, Nagoya-shi Aichi-ken (JP)

(73) Assignee: TOYOTA JIDOSHA KABUSHIKI KAISHA, Toyota-shi Aichi-ken (JP)

(21) Appl. No.: 18/673,982

(22) Filed: May 24, 2024

(30) Foreign Application Priority Data
May 30, 2023 (JP) 2023-089128

(51) Int. Cl. B60W 60/00

(52) U.S. Cl. CPC B60W 60/0015; B60W 2420/403; B60W 2420/408

(57) ABSTRACT

The self-propelled conveyance system acquires first spatial information of the vehicle by a first sensor and acquires second spatial information of the vehicle by the second sensor having a modality different from that of the first sensor. The processor of the self-propelled conveyance system calculates a first position of the vehicle in a predetermined coordinate system based on the first spatial information and calculates a second position of the vehicle in the predetermined coordinate system based on the second spatial information. Then, the processor determines a deviation between the first position and the second position and generates a control instruction for the vehicle based on at least one of the first position and the second position on condition that the deviation is within an allowable range.

### CROSS-REFERENCE TO RELATED APPLICATION

The present application claims priority under 35 U.S.C. § 119 to Japanese Patent Application No. 2023-089128, filed on May 30, 2023, the contents of which application are incorporated herein by reference in their entirety.

### BACKGROUND

### Field

The present disclosure relates to a self-propelled conveyance system that conveys a vehicle by self-propelling the vehicle.

### Background Art

A self-propelled conveyance system that transports a vehicle by self-propelling is known. As a conventional technique related to the self-propelled conveyance system, for example, a technique disclosed in JP2022-134583A can be cited. JP2022-134583A discloses a technique for remotely controlling a plurality of micromobility vehicles traveling in an automatic operation area by a fixed infrastructure device. The fixed infrastructure device includes a LiDAR that detects a target in a detection range defined in the automatic operation area. The fixed infrastructure device generates a travel route of a micromobility vehicle traveling within the detection range using detection information of objects detected by the LiDAR, and transmits a control command based on the travel route to the micromobility vehicle.

In addition to JP2022-134583A, JP2022-157096A and JP2022-157033A can be exemplified as documents showing the technical level of the technical field related to the present disclosure.

### SUMMARY

In the self-propelled conveyance system, the position of the vehicle is required to create a control instruction to the vehicle. The applicant has been studying a technique of acquiring an image of a vehicle by a fixed camera installed in a space in which the vehicle is conveyed and calculating the position of the vehicle based on the image. However, in the process of the studying, it has been found that all places on the conveyance route of the vehicle cannot be necessarily photographed by the fixed camera due to the restriction in installing the fixed camera. When there is a place where the position of the vehicle cannot be calculated, a problem occurs in the self-propelled conveyance of the vehicle.

The present disclosure has been made in view of the above problems. An object of the present disclosure is to provide a self-propelled conveyance system that prevents a failure from occurring in conveying a vehicle by self-propelling the vehicle

The self-propelled conveyance system of the present disclosure includes two types of sensors, that is, a first sensor and a second sensor. The first sensor is a sensor that acquires spatial information of the vehicle. The second sensor is also a sensor that acquires spatial information of the vehicle. However, the second sensor is a sensor having a modality different from that of the first sensor. Therefore, the spatial information of the vehicle acquired by the first sensor (hereinafter, referred to as first spatial information) and the spatial information of the vehicle acquired by the second sensor (hereinafter, referred to as second spatial information) are different types of information. The first sensor may be provided separately from the vehicle in the space where the vehicle is conveyed.

The self-propelled conveyance system of the present disclosure includes at least one processor for processing the first spatial information and the second spatial information, and at least one memory for storing a plurality of instructions to be executed by the at least one processor. The plurality of instructions is configured to cause at least one processor to perform predetermined processing. The processing executed by the processor includes calculating a first position of the vehicle in a predetermined coordinate system based on the first spatial information and calculating a second position of the vehicle in the predetermined coordinate system based on the second spatial information. Further, the processing executed by the processor includes determining a deviation between the first position and the second position, and generating a control instruction for the vehicle based on at least one of the first position and the second position on condition that the deviation is within an allowable range.

The processing executed by the processor may include generating the control instruction based on one of the first position and the second position. The processing executed by the processor may include switching the position of the vehicle, which is a basis of the control instruction, from the first position to the second position or from the second position to the first position on condition that the deviation is within the allowable range. The process executed by the processor may include instructing the vehicle to stop or take a retreat action when the deviation is outside the allowable range.

According to the self-propelled conveyance system of the present disclosure, the position of the vehicle can be calculated using two types of sensors of different modalities. Both the first position calculated based on the spatial information acquired by the first sensor and the second position calculated based on the spatial information acquired by the second sensor can be used to create the control instruction for the vehicle. However, since the condition for using the first position or the second position is that the deviation between the first position and the second position is within the allowable range, it is possible to prevent a problem in the self-propelled conveyance of the vehicle from occurring due to the influence of the deviation in the position on the control instruction.

### BRIEF DESCRIPTION OF THE DRAWINGS

FIG. 1 is a schematic diagram of a self-propelled conveyance system according to an embodiment of the present disclosure;

FIG. 2 is a diagram for explaining switching of a vehicle position used for calculation of a control instruction;

FIG. 3 is a diagram showing an example of a positional deviation within an allowable range;

FIG. 4 is a diagram showing an example of a positional deviation outside the allowable range;

FIG. 5 is a block diagram showing the details of the configuration of the self-propelled conveyance system according to the embodiment of the present disclosure; and

FIG. 6 is a flowchart showing a process executed in the self-propelled conveyance system according to the embodiment of the present disclosure.

### DETAILED DESCRIPTION

1. Overview of Self-Propelled Conveyance System

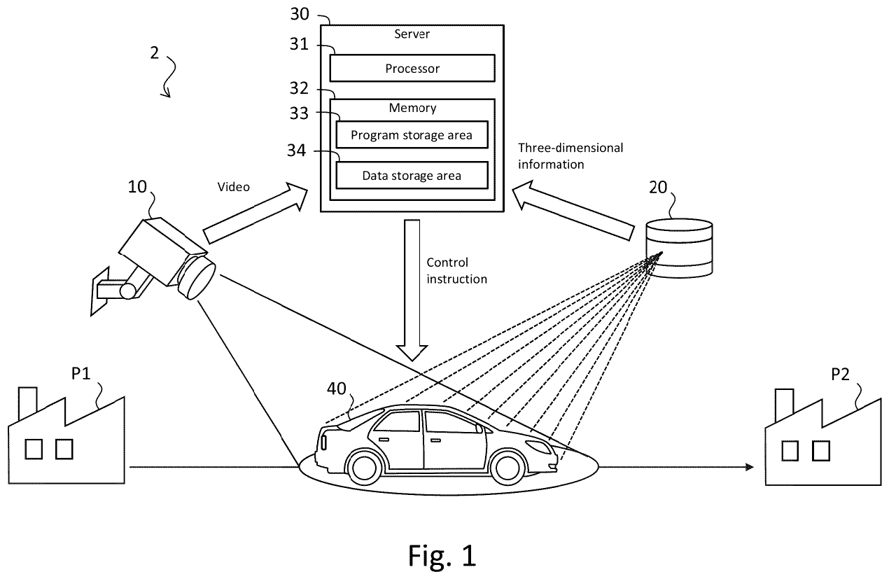

FIG. 1 shows an overview of a self-propelled conveyance system 2 according to an embodiment of the present disclosure. The self-propelled conveyance system 2 is a system that conveys a vehicle 40 having a self-propelled function from a departure place P1 to a destination P2 by self-propelling the vehicle 40. The self-propelled conveyance system 2 can be constructed as a system for moving a completed vehicle in a factory or a warehouse, for example. The self-propelled conveyance system 2 can also be constructed as an automatic valet parking system.

The self-propelled conveyance system 2 includes two types of sensors for acquiring spatial information of the vehicle 40. The difference between the two types of sensors is the difference in modality. Specifically, the first sensor included in the self-propelled conveyance system 2 is the camera 10 that acquires an image of the vehicle 40 as the spatial information of the vehicle 40. The second sensor included in the self-propelled conveyance system 2 is the LiDAR 20 that acquires three-dimensional information of the vehicle 40 as spatial information of the vehicle 40.

At least one camera 10 is installed in a space where the vehicle 40 is conveyed. Specifically, the camera 10 is disposed at a position where the camera 10 can look down on the conveyance route of the vehicle 40 from the departure place PI to the destination P2. However, depending on the target to which the self-propelled conveyance system 2 is applied, the camera 10 may not be installed so as to capture the entire transport route due to the restriction in installing the camera 10.

At least one LiDAR 20 is installed in a space in which the vehicle 40 is conveyed. The installation conditions of the LiDAR 20 are less strict than those of the camera 10. Therefore, the LiDAR 20 may be installed even in a place where the camera 10 is difficult to install. The spatial information of the vehicle 40 is acquired in all the conveyance routes of the vehicle 40 by the cooperation of the camera 10 and the LiDAR 20.

The self-propelled conveyance system 2 includes a server 30. The server 30 transmits a control instruction for causing the vehicle 40 to travel by itself to the vehicle 40. The control instruction includes instruction values related to driving, braking, and steering of the vehicle 40. Information on which the server 30 creates the control instruction is based is information on the position of the vehicle 40. The position of the vehicle 40 can be calculated from the spatial information of the vehicle 40. Therefore, the server 30 receives the video as the first spatial information from the camera 10 and receives the three-dimensional information as the second spatial information from the LiDAR 20. The server 30 calculates the position of the vehicle 40 based on the received spatial information, and generates a control instruction for the vehicle 40 based on the position of the vehicle 40.

The server 30 includes at least one processor 31 (hereinafter, simply referred to as a processor 31). The server 30 also includes at least one memory 32 (hereinafter referred to simply as memory 32) communicatively coupled to the processor 31. The memory 32 includes a program storage area 33 and a data storage area 34. The program storage area 33 stores a plurality of instructions including an instruction for causing the processor 31 to calculate the position of the vehicle 40 and an instruction for causing the processor 31 to create a control instruction. The data storage area 34 stores data necessary for executing the instruction, and temporarily stores data such as the video acquired from the camera 10 and the three-dimensional information acquired from the LIDAR 20.

2. Details of Self-Propelled Conveyance System

The control instruction can be generated using at least one of the position of the vehicle 40 calculated from the video acquired by the camera 10 (hereinafter, may be referred to as a first vehicle position) and the position of the vehicle 40 calculated from the three-dimensional information acquired by the LiDAR 20 (hereinafter, may be referred to as a second vehicle position). In the present embodiment, the server 30 uses either the first vehicle position calculated based on the video of the camera 10 or the second vehicle position calculated based on the three-dimensional information of the LiDAR 20.

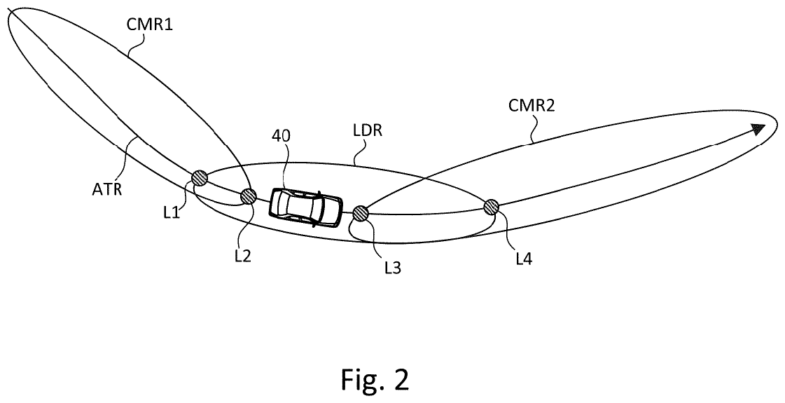

As described above, due to the restriction in installing the camera 10, a region that cannot be captured by the camera 10 may be generated in the conveyance route of the vehicle 40. In the present embodiment, it is assumed that an area outside the imaging area of the camera 10 exists in the conveyance route of the vehicle 40, and the LiDAR 20 is installed so as to scan the area. In detail, as shown in FIG. 2, the imaging areas CMR 1 and CMR2 of the camera 10 are set along the self-propelled conveyance route ATR of the vehicle 40. The imaging region CMR1 and the imaging region CMR2 are regions imaged by different cameras 10, and are not connected to each other. A scanning region LDR of the LiDAR 20 is set between the imaging region CMR1 and the imaging region CMR2. There is an overlap between the scanning region LDR and the imaging region CMR1, and there is also an overlap between the scanning region LDR and the imaging region CMR2.

When the vehicle 40 is in the imaging area CMR1, the server 30 can calculate the position of the vehicle 40 from the video. When the vehicle 40 advances to the scanning region LDR, the server 30 can calculate the position of the vehicle 40 from the three-dimensional information. When the vehicle 40 has advanced to the imaging area CMR2, the server 30 can calculate the position of the vehicle 40 from the video again. In the present embodiment, the server 30 generates the control instruction based on one of the first vehicle position and the second vehicle position. Therefore, the server 30 needs to switch the position of the vehicle 40, which is the basis for creating the control instruction, from the first vehicle position to the second vehicle position between the start point L1 and the end point L2 of the overlap between the imaging region CMR1 and the scanning region LDR. In addition, the server 30 needs to switch the position of the vehicle 40, which is a basis for creating the control instruction, from the second vehicle position to the first vehicle position between the start point L3 and the end point L4 of the overlap between the scanning region LDR and the imaging region CMR2.

However, the first vehicle position calculated based on the video of the camera 10 and the second vehicle position calculated based on the three-dimensional information of the LiDAR 20 do not necessarily coincide with each other. When the deviation between the first vehicle position and the second vehicle position is large, the behavior of the vehicle 40 may become unstable due to the switching of the vehicle position that is the basis for the creation of the control instruction. Therefore, the server 30 is required to determine whether or not the positional deviation between the first vehicle position and the second vehicle position is within the allowable range before switching from the first vehicle position to the second vehicle position or from the second vehicle position to the first vehicle position. The deviation of the position within the allowable range means a deviation of the position in which a change in the behavior of the vehicle 40 caused by the switching of the vehicle position falls within the allowable range in self-propelling the vehicle 40 in a yard such as a factory, a warehouse, or a parking lot.

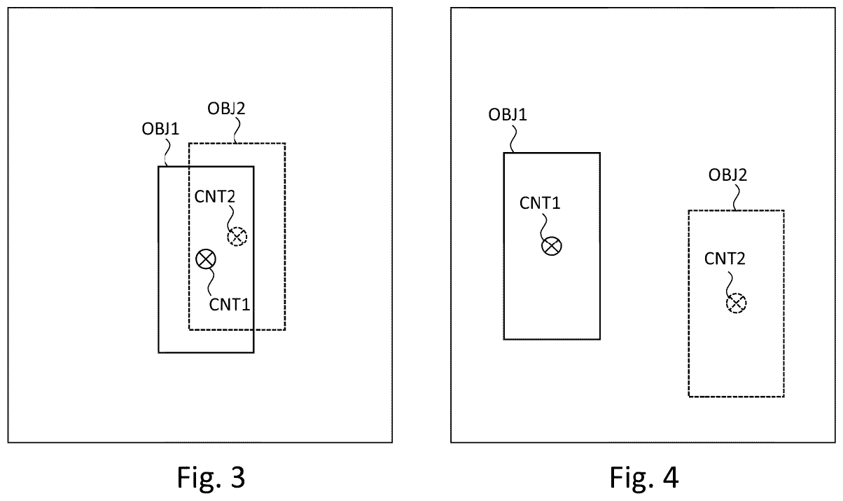

An example of a method for determining whether or not the positional deviation is within the allowable range will be described with reference to FIGS. 3 and 4. FIGS. 3 and 4 show two bounding boxes OBJ1 and OBJ2 projected onto a predetermined coordinate space. The bounding box OBJ1 indicates the position of the vehicle 40 obtained by the object recognition processing on the video of the camera 10. The bounding box OBJ2 indicates the position of the vehicle 40 obtained by the object recognition processing on the three-dimensional information of the LiDAR 20. In FIGS. 3 and 4, the centroids CNT1 and CNT2 of the respective bounding boxes OBJ1 and OBJ2 are shown.

In the example shown in FIG. 3, the centroids CNT1 and CNT2 of the two bounding boxes OBJ1 and OBJ2 are close to each other, whereas in the example shown in FIG. 4, the two centroids CNT1 and CNT2 are far away from each other. Therefore, as one method of determining whether or not the positional deviation is within the allowable range, distances between the centroids CNT1 and CNT2 of the bounding boxes OBJ1 and OBJ2 can be used. For example, if the distance between the centroids is equal to or less than a threshold value, it may be determined that the positional deviation is within the allowable range. On the other hand, if the distance between the centroids is larger than the threshold value, it may be determined that the positional deviation is outside the allowable range.

In the example shown in FIG. 3, the two bounding boxes OBJ1 and OBJ2 overlap each other, whereas in the example shown in FIG. 4, the two bounding boxes OBJ1 and OBJ2 do not overlap each other. Therefore, as another method of determining whether or not the positional deviation is within the allowable range, the overlap ratio between the bounding boxes OBJ1 and OBJ2 can be used. For example, if the overlap ratio is equal to or less than a threshold value, it may be determined that the positional deviation is within the allowable range. On the other hand, if the overlap ratio is larger than the threshold value, it may be determined that the positional deviation is outside the allowable range.

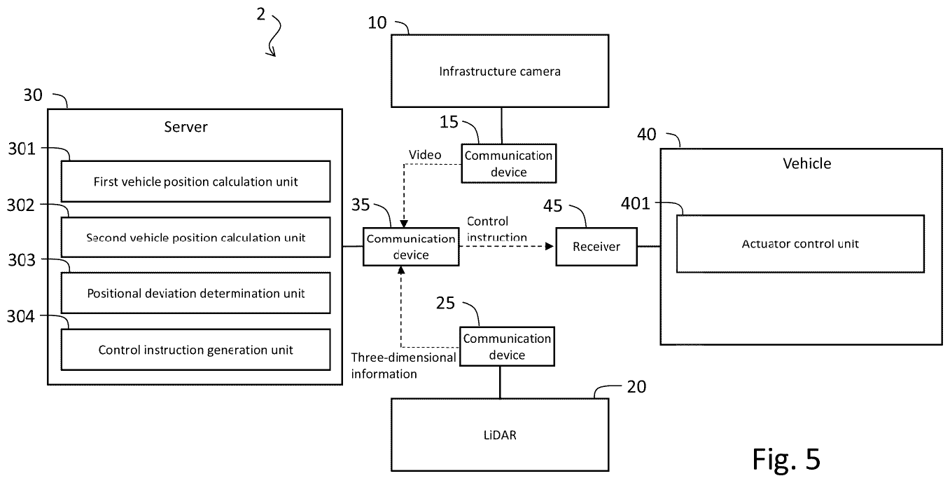

FIG. 5 is a functional block diagram of the self-propelled conveyance system 2 in the case of focusing on the functions of the self-propelled conveyance system 2 including the determination of the deviation of the vehicle position. As shown in FIG. 5, the server 30 includes a first vehicle position calculation unit 301, a second vehicle position calculation unit 302, a positional deviation determination unit 303, and a control instruction generation unit 304. The memory 32 stores instructions for causing the processor 31 to execute the processing executed in these elements 301 to 304. That is, when the instructions corresponding to these elements 301 to 304 are executed by the processor 31, the processes defined in these elements 301 to 304 are executed by the processor 31.

The first vehicle position calculation unit 301 acquires the video of the vehicle 40 from the infrastructure camera 10. The infrastructure camera 10 and the server 30 are connected to each other by wire or wirelessly by the communication devices 15 and 35. The first vehicle position calculation unit 301 performs predetermined object recognition processing on the video acquired from the infrastructure camera 10 and recognizes the vehicle 40 included in the video. The first vehicle position calculation unit 301 projects the vehicle 40 recognized from the video onto a predetermined coordinate system, and calculates the first vehicle position on the coordinate system.

The second vehicle position calculation unit 302 acquires three-dimensional information of the vehicle 40 from the LiDAR 20. The LIDAR 20 and the server 30 are connected to each other by wire or wirelessly by the communication devices 25 and 35. The second vehicle-position calculating unit 302 performs predetermined object recognition processing on the three-dimensional information acquired from the LiDAR 20, and recognizes the vehicle 40 included in the three-dimensional information. Then, the second vehicle position calculation unit 302 projects the vehicle 40 recognized from the three-dimensional information onto the same coordinate system as the coordinate system on which the first vehicle position is represented, and calculates the second vehicle position in the coordinate system.

The positional deviation determination unit 303 determines whether or not the gap between the first vehicle position and the second vehicle position is within an allowable range. As a determination method, for example, the method described with reference to FIGS. 3 and 4 may be used. The determination result of the positional deviation is input to the control instruction generation unit 304.

The control instruction generation unit 304 creates a control instruction to be given to the vehicle 40 based on the vehicle position. When the vehicle 40 is within the imaging region of the camera 10 but is not within the scanning region of the LiDAR 20, an image including the vehicle 40 is obtained, but three-dimensional information including the vehicle 40 is not obtained. In this case, the control instruction generation unit 304 creates the control instruction based on the first vehicle position calculated based on the video. On the other hand, when the vehicle 40 is not within the imaging region of the camera 10 but within the scanning region of the LiDAR 20, the video including the vehicle 40 is not obtained, but the three-dimensional information including the vehicle 40 is obtained. In this case, the control instruction generation unit 304 generates a control instruction based on the second vehicle position calculated based on the three-dimensional information.

When the vehicle 40 is within the imaging region of the camera 10 and also within the scanning region of the LiDAR 20, both the video including the vehicle 40 and the three-dimensional information including the vehicle 40 are obtained. In this case, the control instruction generation unit 304 performs processing according to the determination result of the positional deviation determination unit 303. When the positional deviation determination unit 303 determines that the positional deviation is within the allowable range, the control instruction generation unit 304 selects one of the first vehicle position and the second vehicle position, and generates a control instruction based on the selected vehicle position. For example, when the vehicle 40 enters the scanning region of the LIDAR 20 from the imaging region of the camera 10, the control instruction generation unit 304 may switch the vehicle position as a basis for generation of the control instruction from the first vehicle position to the second vehicle position at the time when the vehicle 40 enters the scanning region. Further, when the vehicle 40 enters the imaging region of the camera 10 from the scanning region of the LiDAR 20, the control instruction generation unit 304 may switch the vehicle position as a basis of generation of the control instruction from the second vehicle position to the first vehicle position at the time when the vehicle 40 enters the imaging region.

When the positional deviation determination unit 303 determines that the positional deviation is out of the allowable range, the control instruction generation unit 304 generates an emergency control instruction. The emergency control instruction is a control instruction for preventing the behavior of the vehicle 40 from becoming unstable due to switching of the vehicle position in a state where the positional deviation occurs. Specifically, a stop instruction for instructing the vehicle 40 to stop is created so that the vehicle 40 is stopped at the current location. Instead of the stop instruction, a retreat instruction for instructing the vehicle 40 to perform a retreat action may be generated so that the vehicle 40 retreats to a nearby retreat area.

The control instruction generation unit 304 transmits the created control instruction to the vehicle 40 via the communication device 35 of the server 30. The communication device 35 is wirelessly connected to a receiver 45 of the vehicle 40. The vehicle 40 includes an actuator control unit 401. The actuator control unit 401 controls the drive actuator, the brake actuator, and the steering actuator in accordance with the received control instruction.

Although not shown in FIG. 5, the result of the determination of the positional deviation by the positional deviation determination unit 303 may be used for the abnormality determination of the sensor. That is, if both the camera 10 and the LiDAR 20 are normal, the positional deviation between the first vehicle position and the second vehicle position should be within the allowable range. Therefore, if the positional deviation is outside the allowable range, it can be determined that a failure has occurred in at least one of the camera 10 and the LiDAR 20, or that a deviation has occurred in the setting of at least one of the camera 10 and the LiDAR 20. For example, in the case shown in FIG. 2, it is assumed that a positional deviation occurs between the first vehicle position calculated from the video of the imaging region CMR 1 and the second vehicle position calculated from the three-dimensional information of the scanning region LDR. In this case, it can be determined that an abnormality has occurred in at least one of the camera 10 that is capturing the image of the image capturing region CMR1 and the LiDAR 20 that is scanning the scanning region LDR.

When the vehicle 40 is stopped or the vehicle 40 is caused to take a retreat action by the control instruction from the control instruction generation unit 304, the self-propelled conveyance system 2 needs to be restored at an early stage. Therefore, when the occurrence of the positional deviation is determined by the positional deviation determination unit 303, the administrator of the self-propelled conveyance system 2 may be contacted. At this time, the administrator may be notified of which sensor is abnormal based on the result of the sensor abnormality determination.

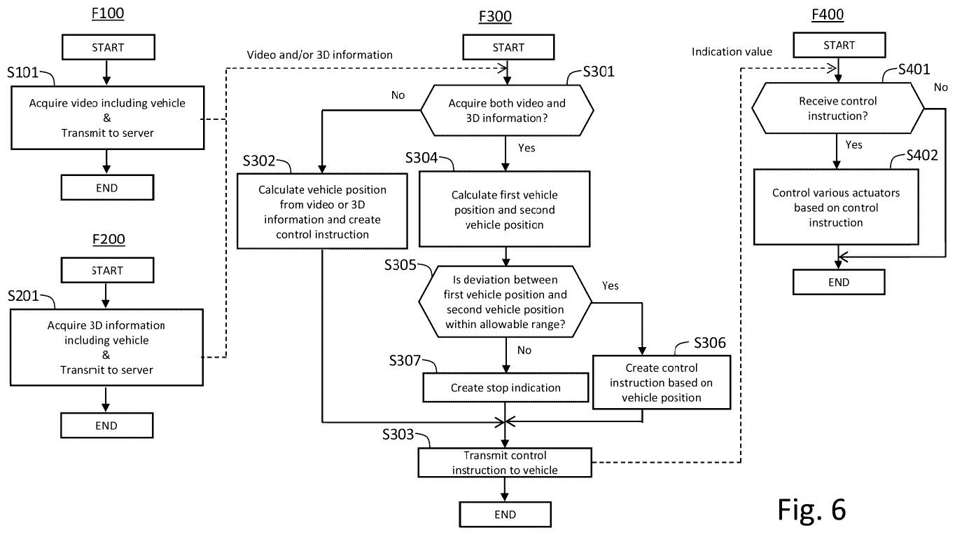

The above-described processing executed by the self-propelled conveyance system 2 can be represented by a flowchart as shown in FIG. 6. In this flowchart, a flow F100 indicates processing executed in the camera 10. A flow F200 indicates processing executed by the LiDAR 20. A flow F300 indicates processing executed by the server 30. A flow F400 indicates processing executed by the vehicle 40. Each flow is executed asynchronously with each other at a predetermined cycle.

As represented by the flow F100, in the camera 10, step S101 is executed. In step S101, a video including the vehicle 40 is acquired. The acquired video is transmitted to the server 30.

As represented by the flow F200, the rider 20 executes step S201. In step S201, three-dimensional information including the vehicle 40 is acquired. The acquired three-dimensional information is transmitted to the server 30.

As represented by the flow F300, in the server 30, first, step S301 is executed. In step S301, it is determined whether both the video and the three-dimensional information have been acquired.

If only one of the video and the three-dimensional information has been acquired, the process proceeds from step S301 to step S302. In step S302, the vehicle position is calculated from the acquired image or three-dimensional information. Then, a control instruction is generated based on the calculated vehicle position. After the execution of step S302, the process proceeds to step S303. In step S303, the control instruction created in step S302 is transmitted to the vehicle 40.

If both the video and the three-dimensional information have been acquired, the process proceeds from step S301 to step S304. In step S304, the first vehicle position is calculated based on the video, and the second vehicle position is calculated based on the three-dimensional information. After the execution of step S304, the process proceeds to step S305. In step S305, it is determined whether or not the positional deviation between the first and second vehicle positions is within an allowable range.

If the positional deviation is within the allowable range, the process proceeds from step S305 to step S306. In step S306, one of the first and second vehicle positions is selected. Then, a control instruction is generated based on the selected vehicle position. After the execution of step S306, the process proceeds to step S303. In step S303, the control instruction created in step S306 is transmitted to the vehicle 40.

If the positional deviation is outside the allowable range, the process proceeds from step S305 to step S307. In step S307, a stopping instruction for stopping the vehicle 40 is generated. After the execution of step S307, the process proceeds to step S303. In step S303, the stopping instruction generated in step S306 is transmitted to the vehicle 40 as a control instruction.

As shown in the flow F400, in the vehicle 40, first, step S401 is executed. In step S401, it is determined whether or not a control instruction has been received. When the control instruction is received, the process proceeds to step S402. In step S402, various actuators are controlled based on the control instruction received in step S306.

3. Other Embodiments

The vehicle 40 may include a remote driving kit for realizing remote manual driving by a remote operator. If the vehicle 40 is provided with a remote operation kit, the conveyance of the vehicle 40 may be switched from self-propelled conveyance by transmission of a control instruction to conveyance by remote manual operation when the positional deviation is outside the allowable range.

In the region where the imaging region CMR1 and the scanning region LDR overlap each other and the region where the scanning region LDR and the imaging region CMR2 overlap each other shown in FIG. 2, both the video and the three-dimensional information are acquired. In such a region, an intermediate position between the first vehicle position and the second vehicle position may be calculated, and the control instruction may be generated based on the intermediate position. The vehicle position on which the control instruction is generated may be gradually switched from the first vehicle position to the second vehicle position or from the second vehicle position to the first vehicle position.

The combination of sensors applicable to the self-propelled conveyance system is not limited to the installation type camera and the installation type LiDAR. For example, when the first sensor is a stationary camera, the second sensor may be a vehicle LiDAR. A radar may be used as the second sensor. The radar may be installed or mounted on a vehicle. When the second sensor is a radar, a LiDAR may be used as the first sensor. The second sensor may be a GPS receiver mounted on the vehicle or a magnetic sensor provided on the road surface. That is, the first sensor and the second sensor may acquire the spatial information of the vehicle and have different sensor modalities.

What is claimed is:

1. A self-propelled conveyance system for conveying a vehicle by self-propelling the vehicle, comprising:
a first sensor configured to acquire spatial information of the vehicle;
a second sensor configured to acquire spatial information of the vehicle, the second sensor having a modality different from a modality of the first sensor;
at least one processor configured to process first spatial information of the vehicle acquired by the first sensor and second spatial information of the vehicle acquired by the second sensor; and
at least one memory storing a plurality of instructions to be executed by the at least one processor, wherein the plurality of instructions is configured to cause the at least one processor to execute:
calculating a first position of the vehicle in a predetermined coordinate system based on the first spatial information,
calculating a second position of the vehicle in the predetermined coordinate system based on the second spatial information,
determining a deviation between the first position and the second position, and
generating a control instruction for the vehicle based on at least one of the first position and the second position on condition that the deviation is within an allowable range.

2. The self-propelled conveyance system according to claim 1, wherein
the plurality of instructions is configured to further cause the at least one processor to execute:
generating the control instruction based on one of the first position and the second position, and
switching the position of the vehicle, which is a basis of the control instruction, from the first position to the second position or from the second position to the first position on condition that the deviation is within the allowable range.

3. The self-propelled conveyance system according to claim 1, wherein
the plurality of instructions is configured to further cause the at least one processor to execute:
instructing the vehicle to stop or take a retreat action when the deviation is outside the allowable range.

4. The self-propelled conveyance system according to claim 1, wherein
the first sensor is a sensor provided separately from the vehicle in a space in which the vehicle is conveyed.

5. The self-propelled conveyance system according to claim 4, wherein
the first sensor is a camera configured to acquire a video as the first spatial information, and
the second sensor is a LiDAR configured to acquire three-dimensional information as the second spatial information.
